(19) United States
(12) Patent Application Publication
(10) Pub. No.: US 2011/0270603 A1
(43) Pub. Date: Nov. 3, 2011

(54) Method and Apparatus for Language Processing

(75) Inventors: Joel Ovil, Johannesburg (ZA); Liran Brener, Hod Hasharon (IL)

(73) Assignee: WHITESMOKE, INC., WILMINGTON, DE (US)

(21) Appl. No.: 13/031,407

(22) Filed: Feb. 21, 2011

Related U.S. Application Data
(63) Continuation of application No. 10/613,146, filed on Jul. 3, 2003, now abandoned.
(60) Provisional application No. 60/401,326, filed on Aug. 7, 2002.

(51) Int. Cl. G06F 17/27

(52) U.S. Cl. 704/9

(57) ABSTRACT

A method for language enhancement, including receiving text, identifying grammatical constructs within the text, and suggesting at least one alternate text portion for at least one original portion of the text, the alternate text portion being consistent with the grammatical constructs of the original portion and having substantially the same meaning as the original portion but conveying a different impression. Apparatus is also described and claimed.

### PRIORITY REFERENCE TO RELATED APPLICATIONS

This application claims benefit of and hereby incorporates by reference U.S. Provisional application No. 60/401,326, entitled “METHOD AND APPARATUS FOR LANGUAGE PROCESSING”, filed on Jul. 8, 2002 by inventors Joel Ovil and Liran Brener.

### FIELD OF THE INVENTION

The present invention relates to natural language processing, and more specifically to language enhancement.

### BACKGROUND OF THE INVENTION

Conventional prior art natural language processing (NLP) applications comprise many types of language assists, including (i) spell checkers, which check spelling of individual words within text; (ii) grammar checkers, which check grammar of sentences within text; (iii) thesaurus, which provide synonyms to words within text; and (iv) idiom processors, which translate idioms.

### Spell Checkers

Conventional prior art spell checkers examine individual words for spelling errors, and suggest corrections. A familiar spell checker is the one used within Microsoft Word, which marks misspelled words with a red underline, and suggests corrections when a user right clicks on a red underlined word. Spell checkers can operate on-the-fly as character strings are dynamically entered by a user, or as a batch process on an entire document at once. Applications of spell checkers include, for example, word processors, scanners with optical character recognition, and electronic speech-to-text dictaphones.

U.S. Pat. No. 3,995,254 to Rosenbaum describes searching pre-defined lists for misspelled words.

U.S. Pat. No. 5,604,897 to Travis describes use of a database of commonly misspelled words and their suggested corrections.

U.S. Pat. No. 4,799,188 to Yoshimura uses common suffixes to associate misspelled words with suggested corrections.

U.S. Pat. No. 5,148,367 to Saito et al. describes the use of probability tables to determine suggested corrections to a misspelled word.

U.S. Pat. No. 5,970,492 to Nielson describes an Internet-based spell checker.

U.S. Pat. No. 5,787,451 to Mogilevsky describes the use of background spell checking to alleviate time delays for on-the-fly spell checkers. However, the technique of Mogilevsky is suited for local spell checker applications, and does not work well with Internet-based spell checkers, since the background spell checking can only operate when data is not being transferred over the Internet. The above mentioned U.S. Pat. No. 5,970,492 to Nielson for Internet-based spell checking does not address time delay alleviation.

Other spell checkers are described in U.S. Pat. No. 4,498,148 to Glickman, U.S. Pat. No. 4,580,241 to Kucera, U.S. Pat. No. 4,689,768 to Heard et al., U.S. Pat. No. 4,797,855 to Duncan IV et al., U.S. Pat. No. 4,799,191 to Yoshimura, U.S. Pat. No. 4,829,472 to McCourt et al., U.S. Pat. No. 4,842,428 to Suzuki, U.S. Pat. No. 4873634 to Frisch et al., U.S. Pat. No. 4903206 to Itoh et al., U.S. Pat. No. 4915546 to Kobayashi et al., U.S. Pat. No. 4980855 to Kojima, U.S. Pat. No. 4995740 to Kobayashi, U.S. Pat. No. 5203705 to Hardy et al., U.S. Pat. No. 5215388 to Shibaoka, U.S. Pat. No. 5218536 to McWherter, U.S. Pat. No. 5765180 to Travis, U.S. Pat. No. 5802537 to Makita, U.S. Pat. No. 6219453 to Goldberg and U.S. Pat. No. 6393444 to Lawrence.

### Grammar Checkers

Conventional prior art grammar checkers analyze clauses and full sentences instead of individual words, to detect improper grammatical use. A familiar grammar checker is the one used within Microsoft Word, which marks grammatical errors with a green underline, and suggests corrections when a user right clicks on green underlined text. Grammar checkers can operate on-the-fly as character strings are dynamically entered by a user, or as a batch process on an entire document at once. Applications of grammar checkers include, for example, word processing, information retrieval and language translation.

Whereas spell checkers typically process on a granularity of individual words, grammar checkers typically process on a granularity of clauses or sentences. Many grammar checkers operate by parsing a sentence into language constructs including nouns, pronouns, adjectives, verbs, adverbs, prepositions and conjunctions—similar to the way sentences are diagrammed in language education courses.

Prior art natural language parsers are of two general types, syntactic and semantic. Syntactic parsers are based on grammatical rules. Such parsers typically operate by deriving a parse tree for a sentence, based on a lookup dictionary. Each word in, the sentence is identified as a functional construct and represented as a node in the tree. Syntactic template patterns, referred to as rules or formulas, are fitted with a parsed sentence, and the most appropriate rule is determined.

There are two types of algorithms for syntactic parsing: bottom-up analysis and top-down analysis. Bottom-up analysis operates by first identifying and tagging individual words in a sentence, and then analyzing the sentence. Top-down analysis operates by first matching a sentence to a pre-defined syntactic template, and then analyzing individual words. One of many challenges faced by syntactic parsers is the ambiguity of word usage; namely, that the same word can be used in different ways.

U.S. Pat. No. 5083268 to Hemphill et al. describes use of a parser and predictor, and identifies allowable sentences by approving or disapproving combinations of words.

U.S. Pat. No. 4994966 to Hutchins describes a rule-based grammar checker based on “good rules” and “bad rules”, where bad rules describe grammatical deviations from good rules.

U.S. Pat. No. 4887212 to Zamora et al. describes a syntactic parser that analyzes a sentence in stages of isolation, morphological analysis, dictionary lookup, word expert rules, verb group analysis and clause analysis.

U.S. Pat. No. 5224038 to Bespalko and U.S. Pat. No. 5610812 to Schabes et al. describe tagging parts of speech based on rules.

U.S. Pat. No. 4878750 to Kucera et al., U.S. Pat. No. 5799629 to Schabes et al., U.S. Pat. No. 5822731 to Schultz and U.S. Pat. No. 6292771 to Haug et al. describe use of probability tables based on statistical parameters to check grammar of a sentence whose words have been tagged.

U.S. Pat. No. 5353221 to Kutsumi et al. and U.S. Pat. No. 6243669 to Horiguchi et al. describe translation systems that overcome ambiguity by determination of context.

U.S. Pat. No. 6012075 to Fein et al. describes background grammar checking during a user's idle time in order to alleviate time delay for on-the-fly grammar checkers.

Semantic parsers, on the other hand, are based on comprehending, or understanding contexts of words used in a sentence, and are better able to deal with ambiguity.

U.S. Pat. No. 4674065 to Lange et al. describes determining a context in which a word is used incorrectly and suggesting alternatives, based on a database of homophone; and confusable words.

U.S. Pat. No. 4849898 to Adi describes a method for relating meaning between two words or expressions.

U.S. Pat. No. 5083268 to Hemphill et al. describes predicting parts of speech that follow a given word.

U.S. Pat. No. 5642522 to Zaenen et al. describes analyzing a word according to its context, by matching the word to its neighboring words.

U.S. Pat. No. 5794050 to Dahlgren et al. describes a natural language understanding system used for retrieval.

U.S. Pat. No. 6260008 to Sanfilippo describes disambiguating syntactically related words.

U.S. Pat. No. 6405162 to Segond et al. describes use of pre-defined rules for disambiguating words.

### Other Natural Language Assists

Along with spell and grammar checking, the field of natural language processing also includes tools for assisting a user with text composition. Such tools include an electronic thesaurus and idiom translator.

U.S. Pat. No. 4712174 to Minkler, II describes generating pre-defined poetic or prose text in response to input data.

U.S. Pat. No. 4923314 to Blanchard, Jr. et al. describes an electronic thesaurus, which displays synonyms to words entered by a user.

U.S. Pat. No. 5007019 to Squillante et al. describes maintaining a history of a user's selections from a thesaurus.

U.S. Pat. No. 5237503 to Bedecarrax et al. describes use of tables to disambiguate synonyms and provide a “meaning entry” for synonyms within a thesaurus.

U.S. Pat. No. 5541838 to Koyama et al. describes registering and translating idioms, using a classification of fixed and variable idioms.

U.S. Pat. No. 5644774 to Fukumochi et al. describes a translation system with an idiom processing function.

U.S. Pat. No. 5742834 to Kobayashi describes offering alternatives to sentence components and idioms that are used too frequently.

U.S. Pat. No. 6256605 to MacMillan describes grouping adjectives and adverbs according to meaning, for providing a word's etymology to a user.

U.S. Pat. No. 6389415 to Chase describes generating emotional connotations according to a given profile.

### SUMMARY OF THE INVENTION

The present invention provides a method and apparatus for enhancing natural language composition, by presenting suggestions for enhancement to a user, or author. The present invention can be implemented as standalone software or hardware within a client, or alternatively as a web service within a server-client architecture. Such an on-line web service receives input text from a client and returns suggestions for enhancing the text.

A statement can be expressed in various ways. Careful selection of adjectives, adverbs, verbs and nouns determines the spirit of a statement. Use of certain adjectives and adverbs in a sentence creates an impression on a reader or listener.

The present invention provides a novel capability of enhancing a sentence by adding new parts of text, and by using context equivalent substitutes for existing parts of text. Using the present invention, a user can express a message in a selected style and intonation, thereby improving his linguistic expression.

For example, starting with a sentence such as “I'm happy with your work”, the present invention provides a step-by-step method to convert the sentence into a richer form such as “I'm very pleased with your excellent performance”. The user is provided with context equivalents for words appearing in the original sentence, and is also provided with adjectives and adverbs to insert. The user can accept suggestions provided by the present invention, or choose to ignore them. Moreover, suggestions made by the present invention are preferably validated to ensure that they maintain overall grammatical soundness of the sentence.

In a preferred embodiment, the present invention maintains a plurality of Profiles for language enrichment. A Profile corresponds to a style familiar to a particular class of readers, such as medical professionals, legal professionals and scientific professionals. Using the present invention, a message can be enhanced according to one profile for an attorney or a judge, and enhanced according to a different profile for a physician or a scientist.

In a preferred embodiment, the present invention also builds up a personal Profile for a specific user, based on context equivalents selected and frequently used by the user. In this way, the present invention can enhance a sentence by suggesting to a user his own favorite choice of prose.

The present invention has widespread application, and is particularly advantageous to non-native speakers of a natural language, and to native speakers with poor linguistic abilities. Using the present invention, a non-native speaker need only have a limited knowledge of a foreign language in order to communicate effectively. The present invention is also advantageous to native speakers with good linguistic abilities, who wish to use a vocabulary specific to a particular class of readers.

There is thus provided in accordance with a preferred embodiment of the present invention a method for language enhancement, including receiving text, identifying grammatical constructs within the text, and suggesting at least one alternate text portion for at least one original portion of the text, the alternate text portion being consistent with the grammatical constructs of the original portion and having substantially the same meaning as the original portion but conveying a different impression.

There is further provided in accordance with a preferred embodiment of the present invention language enhancement apparatus, including a memory for storing text, a natural language parser for identifying grammatical constructs within the text, and a natural language enricher for suggesting at least one alternate text portion for at least one original portion of the text, the alternate text portion being consistent with the grammatical constructs of the original portion and having substantially the same meaning as the original portion but conveying a different impression.

There is yet further provided in accordance with a preferred embodiment of the present invention a computer-readable storage medium storing program code for causing a computer to perform the steps of receiving text, identifying grammatical constructs within the text, and suggesting at least one alternate text portion for at least one original portion of the text, the alternate text portion being consistent with the grammatical constructs of the original portion and having substantially the same meaning as the original portion but conveying a different impression.

There is additionally provided in accordance with a preferred embodiment of the present invention a method for eliminating ambiguities in word meanings within a sentence, including for each of a plurality of sentences within a training text: identifying pairs of words, W1 and W2, with known contexts within a sentence, used together in conjunction, and designating matches between pairs of words, V1 and V2, where V1 is contextually equivalent to W1 as used in the sentence, and V2 is contextually equivalent to W2 as used in the sentence, and for a sentence submitted by a user: deriving consistent contexts of words within the sentence, in such a way that pairs of words used in conjunction within the sentence, corresponding to their derived contexts, have matches designated therebetween.

There is moreover provided in accordance with a preferred embodiment of the present invention apparatus for eliminating ambiguities in word meanings within a sentence, including a natural language parser for identifying pairs of words, W1 and W2, with known contexts within a sentence, used together in conjunction, a database manager for designating matches between pairs of words, V1 and V2, where V1 is contextually equivalent to W1 as used in the sentence, and V2 is contextually equivalent to W2 as used in the sentence, and a context analyzer for deriving consistent contexts of words within the sentence, in such a way that pairs of words used in conjunction within the sentence, corresponding to their derived contexts, have matches designated therebetween.

There is further provided in accordance with a preferred embodiment of the present invention a computer-readable storage medium storing program code for causing a computer to perform the steps of for each of a plurality of sentences within a training text: identifying pairs of words, W1 and W2, with known contexts within a sentence, used together in conjunction, and designating matches between pairs of words, V1 and V2, where V1 is contextually equivalent to W1 as used in the sentence, and V2 is contextually equivalent to W2 as used in the sentence, and for a sentence submitted by a user: deriving consistent contexts of words within the sentence, in such a way that pairs of words used in conjunction within the sentence, corresponding to their derived contexts, have matches designated therebetween.

There is yet further provided in accordance with a preferred embodiment of the present invention a web service including receiving a request including one or more sentences of natural language text, deriving at least one suggestion for enhancing the one or more sentences; and returning a response including the at least one suggestion.

There is additionally provided in accordance with a preferred embodiment of the present invention a method for deriving database tables for use in enhancing natural language text, including providing training text conforming to a selected profile, the selected profile corresponding to a specific type of author, and for each of a plurality of sentences within the training text: identifying pairs of words, W1 and W2, with known contexts within a sentence, used together in conjunction, and designating matches between pairs of words, V1 and V2, where V1 is contextually equivalent to W1 as used in the sentence, and V2 is contextually equivalent to W2 as used in the sentence.

There is moreover provided in accordance with a preferred embodiment of the present invention apparatus for deriving database tables for use in enhancing natural language text, including a text receiver for receiving training text conforming to a selected profile, the selected profile corresponding to a specific type of author, a natural language parser for identifying pairs of words, WI and W2, with known contexts within a sentence, used together in conjunction, and a context analyzer for designating matches between pairs of words, V1 and V2, where V1 is contextually equivalent to WI as used in the sentence, and V2 is contextually equivalent to W2 as used in the sentence.

There is further provided in accordance with a preferred embodiment of the present invention a computer-readable storage medium storing program code for causing a computer to perform the steps of providing training text conforming to a selected profile, the selected profile corresponding to a specific type of author, and for each of a plurality of sentences within the training text: identifying pairs of words, W1 and W2, with known contexts within a sentence, used together in conjunction, and designating matches between pairs of words, V1 and V2, where V1 is contextually equivalent to WI as used in the sentence, and V2 is contextually equivalent to W2 as used in the sentence.

There is yet further provided in accordance with a preferred embodiment of the present invention a method for resolving context ambiguity within a natural language sentence, including providing a plurality of context equivalence groups, with specific pairs of the context equivalence groups designated as being matched, a context equivalence group being a group of words of the same grammatical type that are used in the same context, parsing a natural language sentence to identify grammatical types of words within the sentence, identifying context equivalence groups to which words within the sentence belong, and resolving contexts of ambiguous words within the sentence, consistent with matches between the identified context equivalence groups.

There is additionally provided in accordance with a preferred embodiment of the present invention apparatus for resolving context ambiguity within a natural language sentence, including a memory for storing a plurality of context equivalence groups, with specific pairs of the context equivalence groups designated as being matched, a context equivalence group being a group of words of the same grammatical type that are used in the same context, a natural language parser for parsing a natural language sentence to identify grammatical types of words within the sentence, a context identifier for identifying context equivalence groups to which words within the sentence belong, and a context resolver for resolving contexts of ambiguous words within the sentence, consistent with matches between the identified context equivalence groups.

There is moreover provided in accordance with a preferred embodiment of the present invention a computer-readable storage medium storing program code for causing a computer to perform the steps of providing a plurality of context equivalence groups, with specific pairs of the context equivalence groups designated as being matched, a context equivalence group being a group of words of the same grammatical type that are used in the same context, parsing a natural language sentence to identify grammatical types of words within the sentence, identifying context equivalence groups to which words within the sentence belong, and resolving contexts of ambiguous words within the sentence, consistent with matches between the identified context equivalence groups.

The following definitions are employed throughout the specification and claims.

1. Ambiguity—more than one possible meaning for a word
2. Context Equivalence Group, also Group—a group of words of a common. Grammatical Type that can be used to convey the same or a similar meaning. For example, a Group For nouns describing an argument can include words “argument”, “confrontation”, “disagreement”, “dispute”, “fight”, “quarrel” and “spat”; and a Group for adverbs describing the pace of a verb can include words “quickly”, “slowly”, “rapidly”, “hastily” and “fast”. It is noted that Context Equivalence Groups include words that are used in the same context, which includes more than just synonyms.
3. Enrichment Profile, also Profile—a particular writing style, relative to which text is enriched. Profiles include, for example, a general style, a legal style, a medical style and a scientific style. Profiles can also include a writing style specific to a particular author, such as a Mark Twain style, or a Nathaniel Hawthorne style. General and specific Profiles can also be customized for a user's own writing style.
4. Grammatical Type, also Part of Speech—a language element including inter alia noun, pronoun, adjective, verb, adverb, preposition and conjunction.
5. Idiom, also Phrase—a group of words having a special meaning
6. Tagging—identifying the Grammatical Types of words within a sentence

### BRIEF DESCRIPTION OF THE DRAWINGS

The present invention will be more fully understood and appreciated from the following detailed description, taken in conjunction with the drawings in which:

FIG. 1 is a first illustration of a user interface for a language enhancement software application, in accordance with a preferred embodiment of the present invention;

FIG. 2 is a second illustration of a user interface for a language enhancement software application, in accordance with a preferred embodiment of the present invention;

FIG. 3 is a simplified block diagram for a natural language enhancer, in accordance with a preferred embodiment of the present invention;

FIG. 4 is a simplified flowchart for a training, or Learning Phase, in which database tables for a given Profile are populated with linguistic entries, in accordance with a preferred embodiment of the present invention;

FIG. 5 is a simplified flowchart for an Enhancement Phase, in which text is enhanced based on database tables for a given Profile, in accordance with a preferred embodiment of the present invention;

FIG. 6 is a simplified flowchart of identification processing, or tagging, in accordance with a preferred embodiment of the present invention;

FIG. 7A is a simplified flowchart for word-pair match processing, in accordance with a preferred embodiment of the present invention;

FIG. 7B is a simplified illustration of extending a match between word pairs to matches between contextual equivalents thereof, in accordance with a preferred embodiment of the present invention;

FIG. 8 is a simplified flowchart for comprehension processing, in accordance with a preferred embodiment of the present invention;

FIGS. 9A and 9B are simplified flowcharts for usage frequency tabulation, in accordance with a preferred embodiment of the present invention;

FIG. 10 is a simplified flowchart for idiom processing, in accordance with a preferred embodiment of the present invention;

FIG. 11 is a simplified flowchart of a web server embodiment of a natural language enhancer, in accordance with a preferred embodiment of the present invention;

FIG. 12 is a simplified block diagram for a web service version of a natural language enhancer, in accordance with a preferred embodiment of the present invention; and

FIG. 13 a simplified illustration of an example of context resolution for ambiguous words, in accordance with a preferred embodiment of the present invention.

### DETAILED DESCRIPTION OF A PREFERRED EMBODIMENT

The present invention provides a method and apparatus for enhancing natural language text, by presenting suggestions for enhancement to a user, or author. The present: invention can be implemented as standalone software or hardware within a client, or alternatively as a web service within a server-client architecture. Such an on-line web service receives input text from a client and returns suggestions for enhancing the text.

As described hereinabove, prior art word processing programs operate by detecting spelling and grammatical errors and suggesting corrections. Often, suggested corrections to spelling and grammatical errors result in text that diverges from its intended meaning. Such diversions arise, for example, from ambiguities in word usages, from stylistic differences, and from phonetic changes. For example, the expression “hard labor” can refer to effort consuming work, or to a complicated birth; “take off” and “take over” have different meanings, although they both use the same verb; “minute”, as in very small, has different phonetics than “minute”, as in part of an hour; and “running out of” can mean moving quickly, as in “running out of the house”, or depleting, as in “running out of bread”. Use of a word or expression in the wrong context, especially by a non-native speaker of a natural language, leads to confusion and incomprehension.

The present invention overcomes limitations of prior art spelling and grammar checkers, and detects errors caused by ambiguities, as described hereinbelow.

A statement in a natural language can be expressed in a variety of ways. Often, careful selection of nouns, adjectives, verbs and adverbs conveys a special emphasis and spirit. Choice of adjectives and adverbs can make a specific impression. For example, the statement “I'll leave it in your capable hands” conveys a higher level of appreciation than the statement “I'll leave it in your hands”. The adjective “capable” adds spirit to the sentence.

The ability to automatically enhance a sentence by adding new Parts of Speech and by using different contextual equivalents of existing Parts of Speech is a major advance in language processing. The present invention enables a user to express the same basic concept in different styles and intonations. A user of the present invention simply states his intention in a basic form, and the invention takes him through a step-by-step process to obtain a desired linguistic expression. For example, a basic sentence “I'm happy with your work” can be converted into a richer sentence “I'm very pleased with your excellent performance” by changing Parts of Speech and adding new Parts of Speech. According to a preferred embodiment of the present invention, a user chooses among contextual equivalents of words in the sentence, such as (1) “happy”, “content”, “pleased”, “thrilled” or “satisfied”; and (2) “work”, “performance”, “achievement”, “labor” or “results”. Contextual equivalents often reflect different nuances, and bring spirit into a sentence.

Preferably, the present invention also presents new Parts of Speech from which the user can choose. Preferably, changes and additions suggested by the present invention for a sentence maintain overall grammatical soundness of the sentence.

In a preferred embodiment, the present invention organizes groups of words with similar contexts into Context Equivalence Groups, based on classification by Grammatical Type and contextual function. Preferably, words with multiple meanings or Grammatical Types belong to more than one Group. Context Equivalence Groups are useful in resolving ambiguities. Contextual equivalents are more than synonyms—they reflect different styles and can endow a sentence with new dimensions.

In a preferred embodiment, the present invention checks a sentence for spelling errors and grammatical correctness prior to enhancing it.

### User Interface

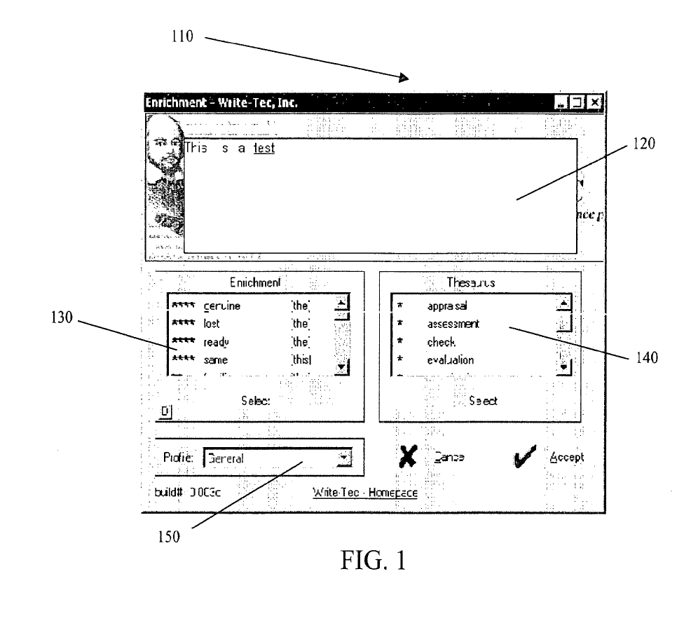

Reference is now made to FIG. 1, which is a first illustration of a user interface for a language enhancement software application, in accordance with a preferred embodiment of the present invention. Shown in FIG. 1 is a screen 110, including a text box 120, a scrollable list of enrichment suggestions 130, and a list of synonyms 140 from a thesaurus. Also included in screen 110 is a list of Profiles 150, through which a user can select a specific Profile relative to which the language enrichment is carried out.

As shown in FIG. 1, a sentence “This is a test” in text box 120 is analyzed. The word “test” is underlined, and the suggestions in list 130 and list 140 apply to this word. List 130 includes adjectives and pronouns that can be combined with the word “test”; for example, “the genuine test”, “lost the test”, and “ready for the test”. List 140 includes synonyms for the word “test”; for example, “appraisal”, “assessment”, and “check”. A user can select items from lists 130 and 140 to enhance the sentence in text box 120.

Items displayed in lists 130 and 140 are ranked by stars; for example, “genuine” in list 130 is ranked with four stars, and “appraisal” in list 140 is ranked with five stars. The stars correspond to a scoring. In a preferred embodiment, the present invention assigns scores to items, preferably according to the frequencies with which they are used in text, although it may be appreciated that other scoring criteria may be used instead of or in combination with usage frequency.

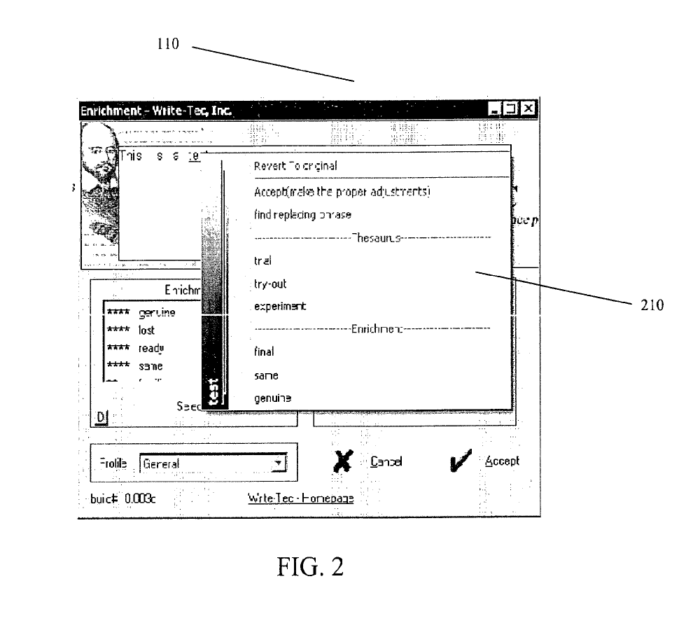

Reference is now made to FIG. 2, which is a second illustration of a user interface for a language enhancement software application, in accordance with a preferred embodiment of the present invention. Shown in FIG. 2 is screen 110 overlaid with a pop-up window 210, enabling the user to accept items from enrichment list 130 and thesaurus list 140 (FIG. 1).

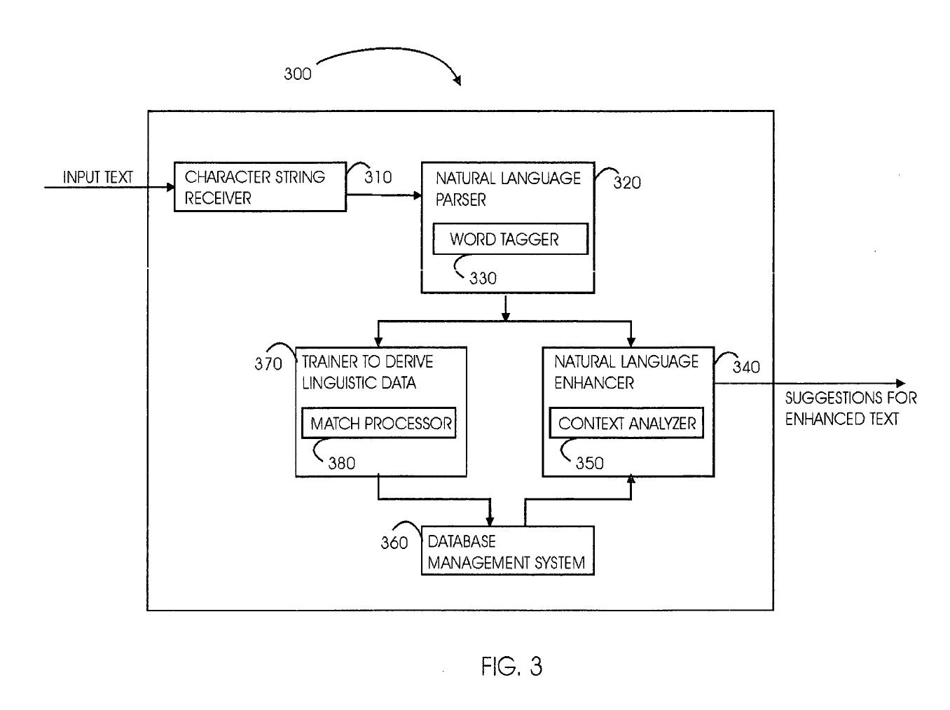

Reference is now made to FIG. 3, which is a simplified block diagram for a natural language enhancer, in accordance with a preferred embodiment of the present invention. Shown in FIG. 3 is a system 300 that processes input text and produces suggestions for enhanced text. As shown in FIG. 3, input text is received by a character string receiver 310, and processed by a natural language parser 320. Natural language parser 320 includes a word tagger 330 that preferably tags, or identifies, the roles of words in sentences from the received text. The tagged text generated by natural language parser 320 is processed by a natural language enhancer 340, which includes a context analyzer 350 for deriving contexts of words in sentences. Based on the derived contexts, natural language enhancer generates one or more suggestions for enhancing the text.

In a preferred embodiment of the present invention, natural language enhancer 340 uses a database of linguistic information in order to derive suggestions. The database is represented in FIG. 3 as a database management system 360. Preferably, database management system 360 is a relational database system. Relational databases store information using linked tables and their column entries. Tables I-XIV described hereinbelow are examples of relational database tables that store linguistic information. It may be appreciated by those skilled in the art that other data structures may be used instead of a relational database, such as XML documents.

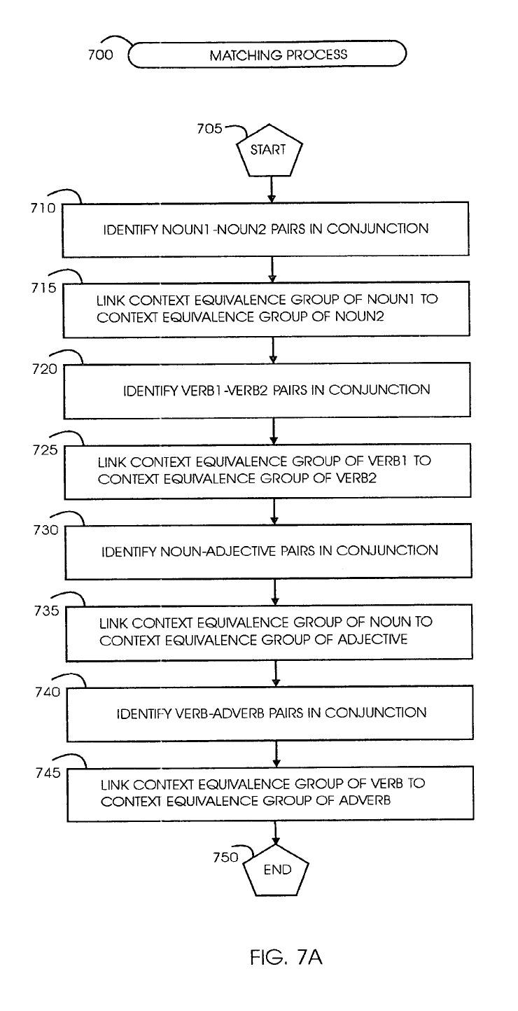

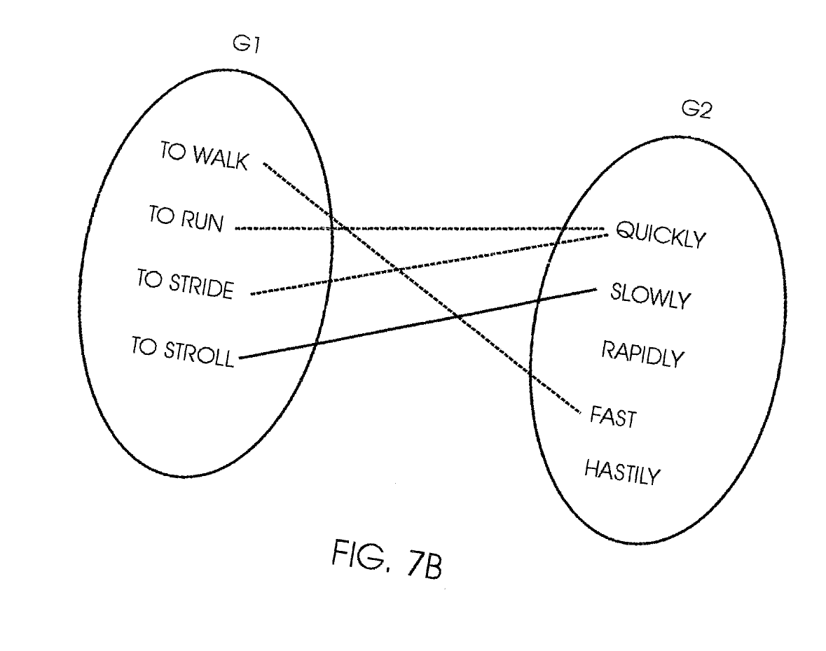

The present invention also provides a method and apparatus for generating the database tables stored in relational database management system 360. Preferably, the database tables are populated by processing text inputs used for training, or learning, by a trainer module 370. Preferably, trainer module 370 receives tagged text from natural language processor 320, but instead of processing the text for enhancement, trainer module 370 processes the text in order to derive linguistic information for storage in database management system 360. Preferably, trainer module 370 includes a match processor 380 for identifying relationships between contexts of words that are used together in conjunction, as described hereinbelow with respect to FIGS. 7A and 7B.

In a preferred embodiment of the present invention, database management system 360 stores linguistic data for a plurality of Profiles, and natural language enhancer 340 and trainer module 370 respectively use and generate linguistic information that is specific to a given Profile. The given Profile may be a specific Profile, such as a medical, legal or scientific Profile, or a general Profile.

As mentioned hereinabove with respect to FIG. 3, in a preferred embodiment the present invention includes two phases: a Learning Phase, in which training text files are analyzed and database tables are populated with linguistic data based thereon; and an Enhancement Phase, in which input text is enhanced based on the tables populated in the learning phase.

### Learning Phase

The Learning Phase analyzes input training text and builds up database tables. Training text can be text from professional publications such as textbooks and journal articles, and text from web pages on the Internet.

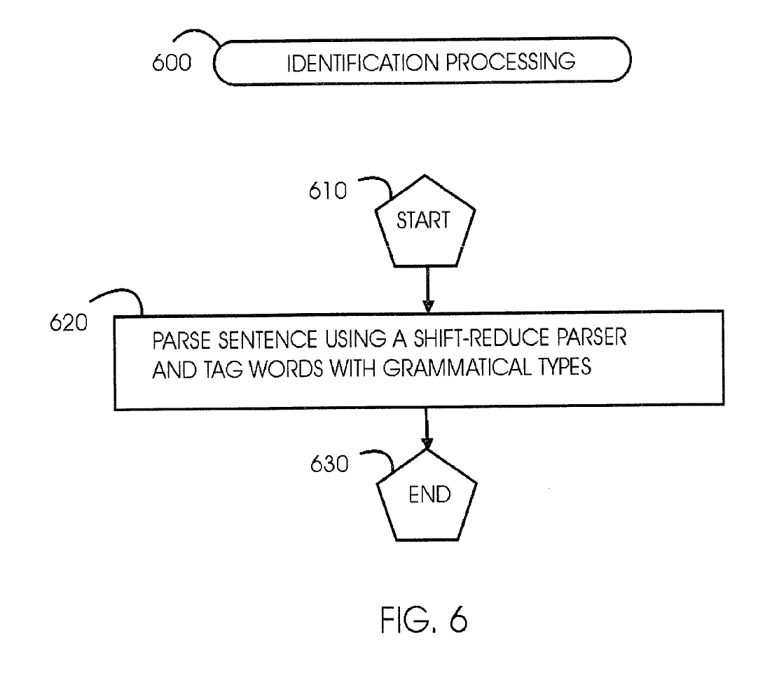

In a preferred embodiment of the present invention, the Learning Phase includes an Identification Process and a Matching Process. The Identification Process preferably identifies words from sentences within input text files, and links the identified words to relevant data within the database. Specifically, the database is searched in an attempt to locate the identified words in the database tables, and information regarding forms of use, Grammatical Type and one or more associated meanings is linked to the words. In addition, words are preferably linked to one or more Context Equivalence Groups that include them. The Identification Process is described hereinbelow with respect to FIG. 6.

Preferably, words are classified into Context Equivalence Groups based on Grammatical Type and context. Words that have usage as more than one Grammatical Type, or that have more than one meaning, preferably appear in more than one Context Equivalence Group.

The Matching Process preferably identifies pairs of Grammatical Types used in conjunction within sentences, as follows:

Noun to noun matching—Nouns that appear in conjunction together, such as nouns that are separated by a preposition or an auxiliary verb, are matched. Preferably, nouns from different sentence components are not matched. For example, in the sentence “His achievement was a breakthrough in the field of mathematics” the nouns “field” and “mathematics” are matched, but neither of them is matched with “achievement”.
Verb to verb matching—Verbs that appear in conjunction together are matched. For example, in the sentence “She wanted to take the dog home”, the verb “to want” is matched with the verb “to take”. Preferably, verbs from different sentence components are not matched.
Adjective to noun matching—Adjective that appear in conjunction with nouns are matched. For example, in the sentence “The sun set into the dark blue sea”, the adjective “dark” and the noun “sea” are matched; and the adjective “blue” and the noun “sea” are also matched. Preferably, nouns are not matched with adjectives in different sentence components.
Adverb to verb matching—Adverbs that appear in conjunction with verbs are matched. For example, in the sentence “He suddenly looked into her eyes and instinctively stepped aside” the adverb “suddenly” is matched with the verb “looked”; and the adverb “instinctively” is matched with the verb “stepped”. Preferably, verbs are not matched with adverbs in different sentence components.
Preposition to noun matching—Prepositions that appear in conjunction with nouns are matched. For example, in the sentence “There was something hidden under the floor”, the preposition “under” is matched with the noun “floor”. Preferably, nouns are not matched with prepositions in different sentence components.

In a preferred embodiment of the present invention, a match between two words is extended to a match between Context Equivalent Groups containing the words. Specifically, after two words, say W1 and W2, are matched, their Context :Equivalence Groups are checked for permissible matching. Specifically, each Context Equivalence Group, say G1, containing W1 is checked for matching with each Context Equivalence Group, say G2, containing W2. For Context Equivalence Group matches that satisfy the check, the Groups themselves are matched, which serves to extend the match between W1 and W2 to pairs of words from the two respective groups. Match information is preferably stored within the database management system 360 (FIG. 3).

For example, in a sentence “The boy gave the flowers to the woman” the noun-verb pairs “boy”-“to give”, “flowers”-“to give”, and “woman”-“to give” are matched. Preferably, when such matching occurs between words that can have more than one meaning, only previously determined meanings of such words are matched. Each Context Equivalence Group containing a noun from the example noun-verb pairs above is checked for matching with each Context Equivalence Group containing the paired verb. Whenever such a link exists, the match is extended so that words in the noun's Context Equivalence Group are matched with words in the verb's Context Equivalence Group. Matching is described hereinbelow with respect to FIG. 7.

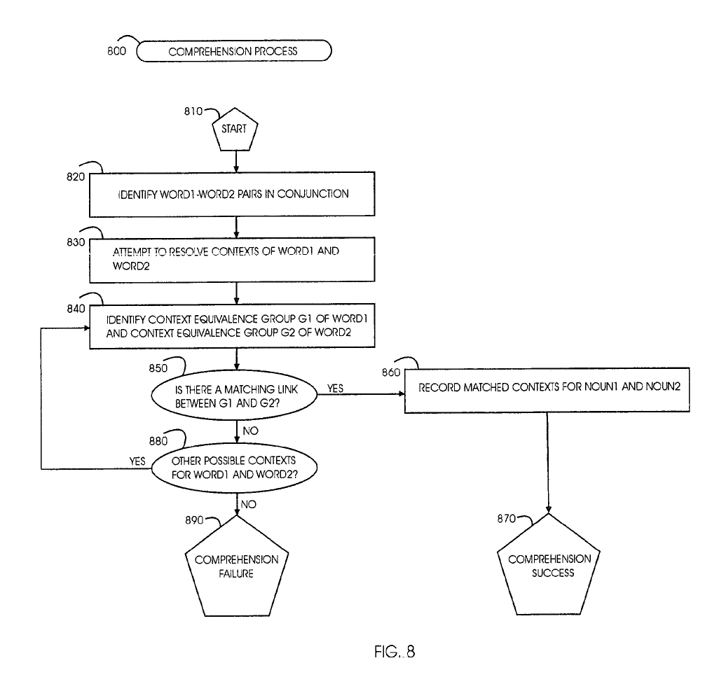

Often, as the database tables are populated, the same words, phrases, noun-adjective pairs, adverb-verb pairs or noun-verb pairs are encountered. In a preferred embodiment, the present invention tracks usage frequencies for word and word pair entries in the database tables, so as to be able to assign a rating, or score, to the entries. Thus, one noun-adjective pair, for example, may be assigned a higher score than another noun-adjective pair, based on usage frequency. Scoring of items in database tables serves to improve the enhancement phase, since the scores can be used to prefer one selection over another. Usage frequency tabulation is described hereinbelow with respect to FIGS. 8A and 8B.

In a preferred embodiment of the present invention, an error profile for a user is derived by storing information relating to errors found in the user's sentences.

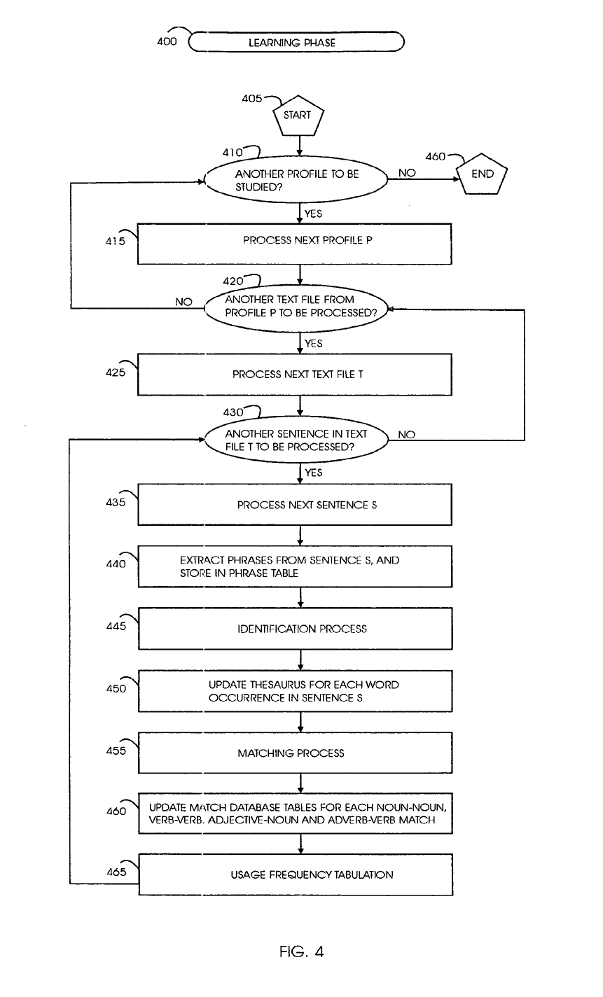

Reference is now made to FIG. 4, which is a simplified flowchart for a Learning, or Training Phase, in which database tables for a given Profile are populated with linguistic entries, in accordance with a preferred embodiment of the present invention. The Learning Phase starts at step 405, and cycles through Profiles. As long as there remains a Profile to be processed, as determined at step 410, a next Profile, P, is chosen at step 415. Afterwards, the Learning Phase cycles through training text files associated with Profile P. As long as there remains a training text file associated with Profile P to be processed, as determined at step 420, a text file, T, is chosen at step 425. Afterwards, the Learning Phase cycles through sentences of text within text file T. As long as there remains a sentence within text file T to be processed, as determined at step 430, a next sentence, S, is chosen at step 435.

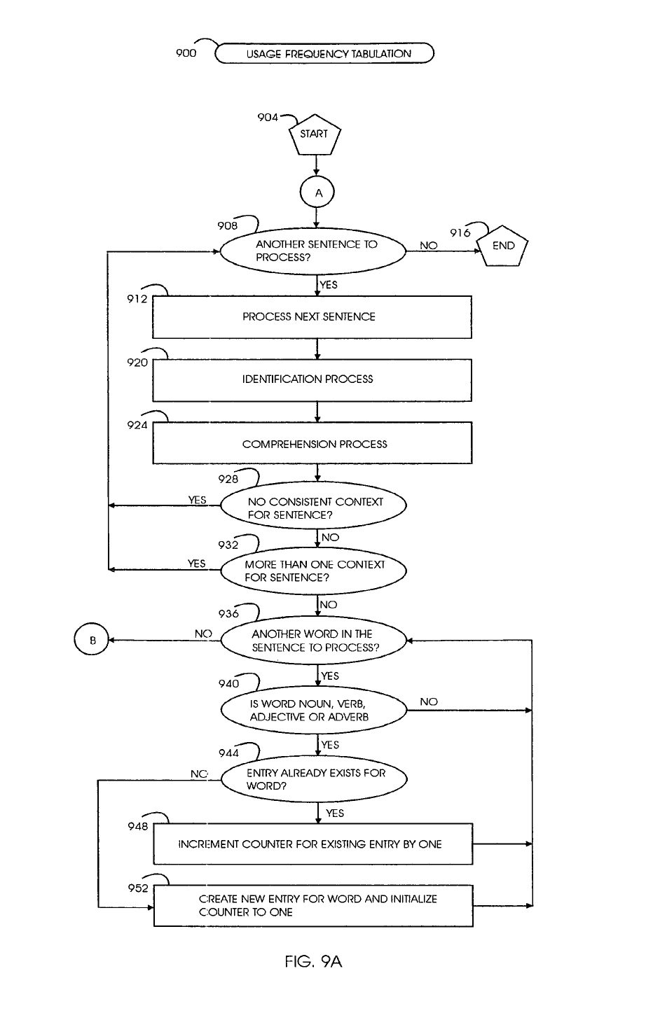

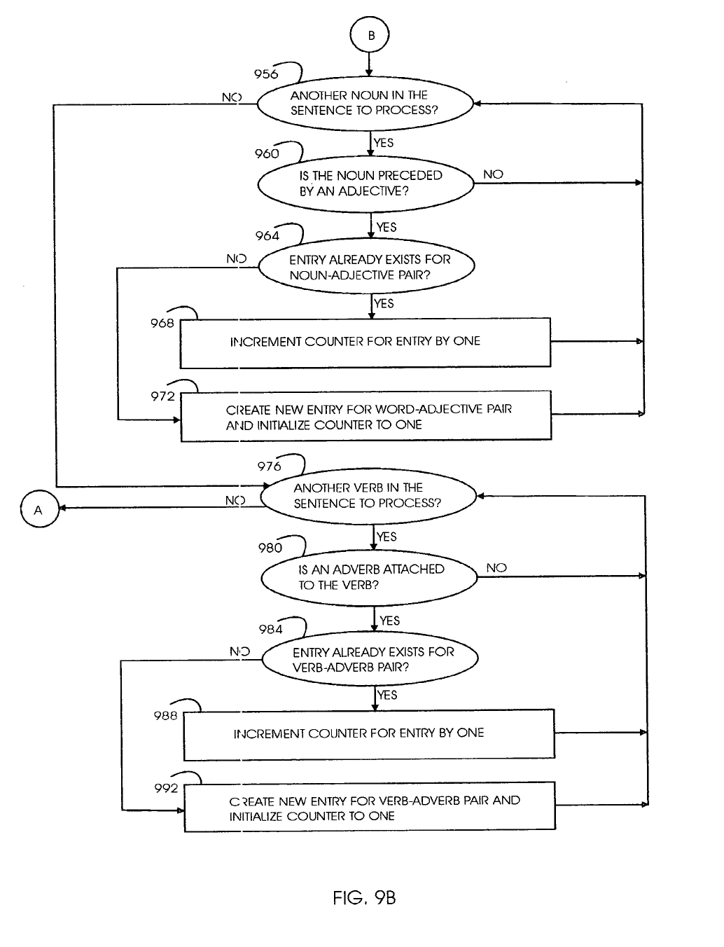

At step 440, the Learning Phase extracts phrases from sentence S and stores them in a Phrase Table described hereinbelow with respect to Table XIII. At step 445, the words in sentence S are tagged according to Grammatical Types, by an Identification Process described below with respect to FIG. 6. At step 450, a thesaurus is updated based on words in sentence S. The thesaurus is preferably stored in one or more database tables. At step 455, combinations of noun-adjective, adverb-verb and noun-verb are matched by a Matching Process and at step 460 the results are stored in one or more appropriate database tables. The Matching Process is described below with respect to FIG. 7. At step 465 usage frequencies are accumulated for database entries, as described below with respect to FIGS. 9A and 9B.

After step 465, control cycles back to step 430, and if there remain unprocessed sentences of text file T, then control proceeds to step 435; otherwise, control cycles back to step 420. If there remain unprocessed training text files for Profile P, then control proceeds to step 425; otherwise, control cycles back to step 410. If there remain unprocessed Profiles, then control proceeds to step 415; otherwise, the Learning Phase ends at step 460.

In a preferred embodiment of the present invention, the Learning Phase also derives writing styles from input text; for example, whether or not an adverb is used before or after a verb. Accordingly, the Enhancement Phase can suggest proper placement of an adverb relative to a verb. Similarly, the Learning Phase derives information about pronouns used with nouns, and propositions used with verbs.

It may be appreciated that the Learning Phase resembles the way the human mind learns word combinations from reading texts, and subsequently uses these combinations in writing.

### Enrichment Phase

In a preferred embodiment of the present invention, the enrichment phase includes an Identification Process and a Comprehension Process. The Identification Process is similar to the Identification Process used in the Learning Phase, and is described hereinbelow with respect to FIG. 6. The Comprehension Process is described hereinbelow with reference to FIG. 9.

The Comprehension Process preferably uses word-pair matches discovered within a sentence to determine contexts of the words. In general, whenever two Grammatical Types appear in conjunction within a sentence, one of the types can be associated with only one context, or meaning of the other type. For example, an adjective appearing before a noun is generally associated with only one context, or meaning of the noun. As such, each word within a sentence generally serves to reduce potential ambiguities in the sentence.

When analyzing a sentence with two Grammatical Types in conjunction, a situation may arise whereby no contextual equivalent of one Grammatical Type matches any contextual equivalent of the other Grammatical Type. Such a situation is referred to herein as a comprehension failure. Preferably, when this occurs a phonetics table is consulted to find words that have similar sounding phonetics but different spellings, which could replace either or both of the two Grammatical Types in the sentence. If a match can then be obtained, such a phonetically similar replacement is suggested to a user for language enhancement. Preferably, replacement words with closer phonetic similarities are suggested to the user first, before suggesting replacements with lesser similarities.

For example, for the sentence “He spoke to his sun”, a match between “speak” and “sun” reveals that none of the contextual equivalents of the verb “to speak” match any of the contextual equivalents of the noun “sun”. Using phonetics tables, the word “son” is discovered and tested as a possible replacement for “sun”. A match is then found between the verb “to speak”, or one of its contextual equivalents, and the noun “son” or one of its contextual equivalents, and accordingly the user is provided with a suggestion to replace “sun” with “son”.

Phonetics tables are used to quantify phonetic similarity. They date back as early as 1918 to the Soundex coding system, in which a four-digit numeral is used to represent phonetic pronunciation of a word. Typically, the Soundex system divides English letters other than “H” and “W” into seven categories, and a numeric representation is assigned to each category. The Soundex system uses an algorithm to convert the numeric representations into a Soundex code. Words with the same Soundex code generally sound alike.

Enhancement is a process for (i) providing suggested contextual equivalents to existing nouns, adjectives, verbs and adverbs; (ii) suggesting new adjectives and adverbs for incorporation in places within the sentences where the sentence can be enhanced, while maintaining grammatical correctness; and (iii) suggesting idioms to replace Parts of Speech and vice versa. Generally, after the Comprehension Process is performed, only one consistent meaningful context reflecting a user's intention is found. During enhancement processing contextual equivalents and additional Grammatical Types that correspond to the meaningful context are suggested to the user. In cases where more than one consistent meaningful context is found, preferably each such meaningful context is addressed, and suggestions are made to the user based on each one.

For example, consider the sentence “I am happy with your work”. The word “happy” appears in conjunction with the correct form, “am”, of the verb “to be” and, as such, can be replaced by another adjective that is a contextual equivalent of happy, such as “pleased”. Similarly, the word “work” can be replaced by a contextually equivalent noun, such as “performance”, “results” or “achievement”. In addition to word replacement, additional words can be added, including contextually associated adverbs such as “absolutely” and “very”, which can be paired with “happy”, and including contextually associated adjectives such as “brilliant”, “extraordinary” and “outstanding”, which can be paired with “work”.

In a preferred embodiment of the present invention, a user can refine the Enrichment Phase by selecting a specific enrichment Profile. Professional Profiles such as legal, medical and scientific Profiles, or linguistic Profiles based on a specific author or poet, can be selected, and accordingly the enhancement phase is constrained to database tables corresponding to the selected Profile.

Preferably, a user can switch between Profiles as often as desired during the Enhancement Phase. If the user does not select a specific Profile, then preferably a general Profile is used as a default for enhancement.

In a preferred embodiment of the present invention, the Enhancement Process ranks words that are suggested to the user, based on stored usage frequencies that were determined during the Learning Phase, as described hereinabove regarding the Learning Phase and hereinbelow with respect to FIGS. 9A and 9B. For example, consider the sentence “They found evidence that he had committed the crime”, and suppose a user selects a legal enrichment Profile. Based on this Profile, adjectives that can precede the noun “evidence” include inter alia words like “circumstantial”, “compelling”, “sufficient”, “insufficient”, “strong”, “weak” and “enough”. Preferably, these adjectives are ranked according to usage frequencies, and the highest-ranking adjectives are presented to the user as suggestions for enhancement, together with a selection “more”, for displaying more adjectives with lower ranking usage frequencies. Alternatively, the user can preferably add an adjective of his own choice, regardless of whether or not it is presented as a suggestion. Similarly, the user can select an adjective to precede the noun “crime”, from suggestions like “vicious”; and he can select an adverb to precede the verb “committed” from suggestions like “intentionally” and “willfully”, the suggestion; being ranked according to usage frequency. In addition, contextual equivalents for the nouns “evidence” and “crime”, and contextual equivalents for the verbs “found” and “committed” are also suggested to the user, ranked according to usage frequency. Alternatively, the user can replace the nouns and verbs with respective nouns and verbs of his own choice, whether or not the replacements are presented as suggestions.

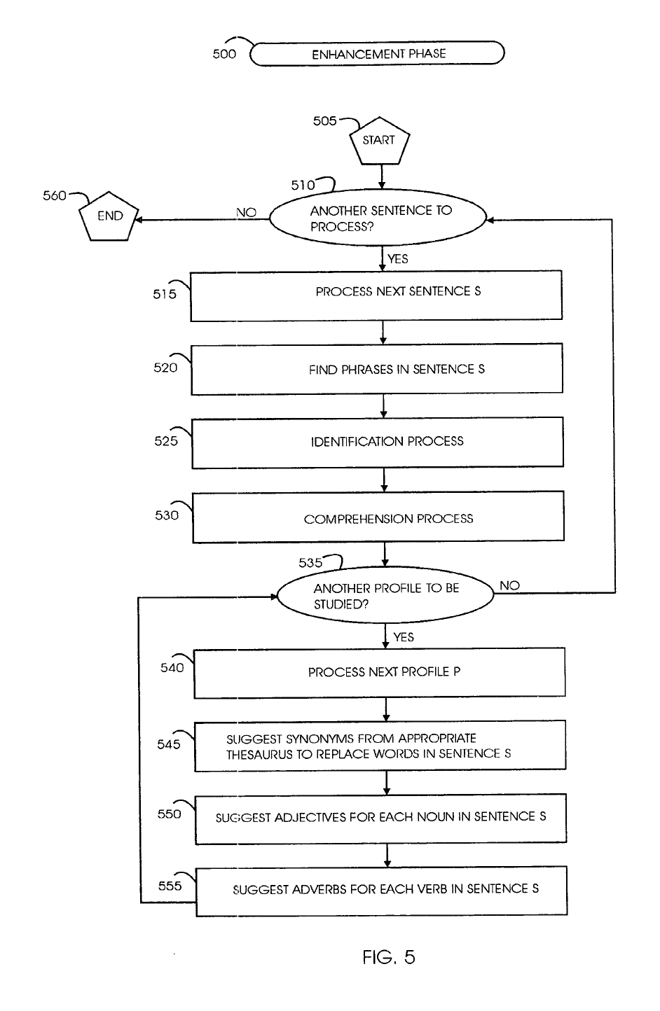

Reference is now made to FIG. 5, which is a simplified flowchart for an Enhancement Phase, in which text is enhanced based on database tables for a given Profile, in accordance with a preferred embodiment of the present invention. The Enrichment Phase starts at step 505, and cycles through sentences of text. As long as there remains a sentence to be processed, as determined at step 510, a next sentence, S, is selected at step 515. At step 520, the Enrichment Phase identifies phrases within sentence S. At step 525, sentence S is parsed and words are tagged according to Grammatical Types, using an Identification Process as described hereinbelow with respect to FIG. 6. At step 530 a Comprehension Process is used to resolve ambiguities and determine contexts for the words in sentence S. The Comprehension Process is described hereinbelow with respect to FIG. 8. As long as there remains a Profile to be processed, as determined at step 535, a next Profile, P, is chosen at step 540. At step 545, the Enhancement Phase suggests synonyms for words in sentence S, based on a thesaurus stored in database tables corresponding to profile P. At step 550, the Enhancement Phase suggests adjectives for each noun, and at step 555 the enrichment phase suggests adverbs for each verb.

After step 555, control cycles back to step 535 and, if there remain unprocessed Profiles, then control proceeds to step 540; otherwise, control cycles back to step 510. If there remain unprocessed sentences of text, then control processed to step 515; otherwise, the Enhancement Phase ends at step 560.

### Identification Processing

Reference is now made to FIG. 6, which is a simplified flowchart of identification processing, or tagging, in accordance with a preferred embodiment of the present invention. Preferably, tagging of words in a sentence is performed by a natural language parser, such as a shift-reduce parser in steps 610-630. Shift-reduce parsers are described in J. Allen, “Natural Language Understanding, 2^{nd} Edition”, 1995, Benjamin Cummings Publishing Co., pages 163-170.

### Matching Processing

Reference is now made to FIG. 7A, which is a simplified flowchart for word pair match processing, in accordance with a preferred embodiment of the present invention. As shown in FIG. 7A, match processing starts at step 705 and at step 710 identifies noun-noun pairs consisting of two nouns, designated noun1 and noun2, used together in conjunction. At step 715 the Context Equivalence Group of noun1, say G1, is matched with the Context Equivalence Group of noun2, say G2, thereby extending the match between noun1 and noun2 to matches between nouns in Group G1 and nouns in Group G2.

Steps 720 and 725 apply similar match processing to verb-verb pairs. Steps 730 and 735 apply similar match processing to noun-adjective pairs, and steps 740 and 745 apply similar match processing to verb-adverb pairs. Processing then terminates at step 750.

Reference is now made to FIG. 7B, which is a simplified illustration of extending a match between word pairs to matches between contextual equivalents thereof, in accordance with a preferred embodiment of the present invention. Shown in FIG. 7B are two Context Equivalence Groups; a first Group G1, for verbs related to movement, and a second Group G2, for adverbs related to pace. If at step 710 (FIG. 7A) forms of the pair of words “to stroll” and “slowly” are used in conjunction, designated by a solid line in FIG. 7B, such as within a sentence “They strolled slowly through the hillside”, then matches are designated between words in G1 and words in G2. For example, as illustrated with dashed lines in FIG. 7B, matches are designated between “to walk” and “last”, between “to run” and “quickly” and between “to stride” and “quickly”.

Preferably, matches between Context Equivalence Groups are stored in a relational database table, such as Table XV hereinbelow.

### Comprehension Processing

Comprehension processing determines contexts for words in a sentence that are viable and consistent with one another. As distinct from spell checkers and grammar checkers, which are local to each word or group of words, comprehension processing applies globally to an entire sentence. Change of a single word in a sentence can impact comprehension of the entire sentence.

In a preferred embodiment of the present invention, comprehension processing analyzes a sentence as a series of components, a component being comprised of one or more words. For example, the phrase “in case of” is treated as if it were one word. The present invention achieves accurate results in sentence analysis, by recognizing components as units instead of as a plurality of individual words.

Comprehension processing determines contexts for words by identifying the Context Equivalence Groups to which the words belong. Different contexts for a word generally correspond to different Context Equivalence Groups.

Comprehension processing can be thought of as an analysis of groups of words used together in conjunction with one another. If the words of a sentence are arranged as nodes of a graph, then edges between words correspond to word pairs used together in conjunction within the sentence. In this framework, comprehension processing can be considered as an assignment of contexts to the nodes of the graph in such a way that the overall sentence is consistent. In order for the contexts of two nodes connected by an edge to be consistent, the corresponding Context Equivalence Groups must have been matched during the matching process (FIG. 7). In other words, consistency requires that the two words connected by an edge, or contextual equivalents thereof, must have been matched during the Learning Phase (FIG. 4). It may thus be appreciated that the edges in the graph create dependencies between contexts of words, and a change in context of one word thus impacts contexts of other words. Reference is now made to FIG. 8, which is a simplified flowchart for comprehension processing, in accordance with a preferred embodiment of the present invention. As shown in FIG. 8, comprehension processing starts at step 810 and at step 820 identifies word pairs, word1-word2, used together in conjunction. At step 830 the process attempts to assign contexts to word1 and word2. At step 840 the process identifies the Context Equivalence Group, G1, of word1, and the Context Equivalence Group, G2, of word2, corresponding to the contexts assigned at step 830.

At step 850 a determination is made whether or not a match was generated between Groups G1 and G2 during the Matching Process (FIG. 7). If so, then at step 850 the current contexts for word1 and word2 are viable and are recorded, and processing ends at step 860. Otherwise, if other possible contexts exist for word1 and word2, as determined at step 870, then the process returns to step 830, and checks whether other contexts are viable. If, at step 870, no other possible contexts exist for word1 and word2 that have not yet been checked for viability, then a comprehension failure is acknowledged at step 880.

### Usage Frequency Tabulation

Preferably, for each Enhancement Profile P, usage frequencies are stored for individual words, in a format

[Word W][Profile P][No. of occurrences N], where N is the number of occurrences of word W within input text corresponding to a specific context in which W appears;

and for associated word pails, in a format

[Word W][Group C][Profile P][No. of occurrences N], where N is the number of occurrences in which word W appears in conjunction with a word from the Context Equivalence Group G.

The [W][P][N] usage frequency indicates the frequency with which word W appears within text conforming to Profile P. The [W][G][P][N] usage frequency indicates the frequency with which an adjective or an adverb W appears in conjunction with a word from Group G, within text conforming to Profile P.

For example, supposed the sentence “His conviction was based on circumstantial evidence” is encountered during the Learning Phase for Profile P. The pair of words “circumstantial” and “evidence” is tallied as [Word “circumstantiall”][Group “evidence”][Profile P][No. of occurrences 15], indicating that “circumstantial” was used in conjunction with nouns within the Context Equivalence Group G to which “evidence” belongs, a total of fifteen times thus far in the Learning Phase.

Reference is now made to FIGS. 9A and 9B, which are simplified flowcharts for usage frequency tabulation, in accordance with a preferred embodiment of the present invention. Tabulation starts at step 904 and if there is another sentence to process, as determined at step 908, a next sentence is processed at step 912. Otherwise, if all sentences have been processed, the tabulation terminates at step 916. At step 920 the Identification Process described above with reference to FIG. 6 is performed, and at step 924 the Comprehension Process described above with respect to FIG. 8 is performed.

The Comprehension Process may result in determination of a single consistent context for the sentence. However, if may also results in a comprehension failure, as illustrated in FIG. 8, if a consistent context cannot be determined, or in comprehension ambiguity if more than one consistent context are determined. If comprehension failure or comprehension ambiguity arises, as determined at steps 928 and 932, then the current sentence is discarded and control returns to step 908. Otherwise, if a single consistent context is determined, then at steps 936 and 940 nouns, verbs, adjectives and adverbs in the sentence are extracted for single-word frequency tabulation. If an entry already exists for the noun, verb, adjective or adverb, as determined at step 944, then its counter is incremented by one at step 948. Otherwise, at step 952 a new entry is created for the noun, verb, adjective or adverb, and its counter is initialized to one.

At steps 956 and 960, noun-adjective pairs where a noun is preceded by an adjective, are extracted from the sentence. If an entry already exists for the noun-adjective pair, as determined at step 964, then its counter is incremented by one at step 968. Otherwise, at step 972 a new entry for the noun-adjective pair is created, and its counter is initialized to one. Similarly, steps 976-992 tabulate verb-adverb pairs, upon completion of which the process returns to step 918 to process another sentence.

### Idiom Processing

Often a sentence can be enhanced by replacing one or more words with an appropriate idiom. In a preferred embodiment of the present invention, as described hereinbelow with respect to Table XII, an idiom is stored together with a list of cues, or key words, the key words being linked to the idiom, each key word having a meaning similar to that of the idiom. Preferably, a key word is either (i) a particular Grammatical Type; or (ii) a root form of a word, as described hereinbelow with respect to Table XIII, in which case all forms derived from the root are also linked to the idiom.

Upon completion of the Comprehension Process (step 530 of FIG. 5), the Enhancement Phase suggests to the user replacement of key words with corresponding idioms. For example, in processing the sentence “Carrying out such an operation is risky”, the word “risky” may be a key word for the idiom “a long shot”. Correspondingly, the user is presented with a suggestion to replace the word “risky” with “a long shot”.

When a key word is replaced with an idiom, this often leads to grammatical errors in the sentence, as correct adverb and adjective forms required for the idiom may differ from the correct forms required for the keyword. Preferably, the present invention derives appropriate suggestions for correcting the grammatical errors according to the proper usage in conjunction with the idiom. Such correcting may include deletion of adverbs, adjectives, prepositions and verbs preceding the keyword, and inserting a connecting verb before the idiom. In a preferred embodiment of the present invention, appropriate connecting verbs for idioms are stored therewith in the database.

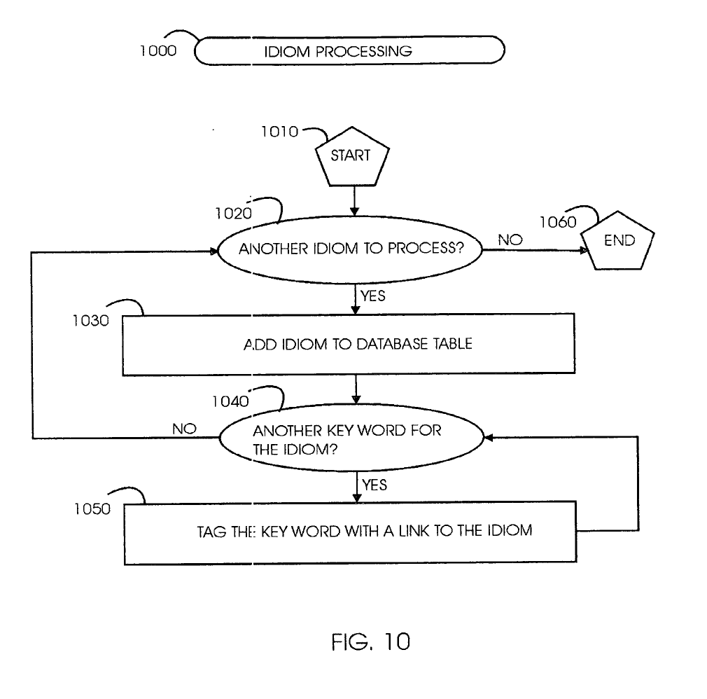

Reference is now made to FIG. 10, which is a simplified flowchart for idiom processing, in accordance with a preferred embodiment of the present invention. As shown in FIG. 10, processing starts at step 1010 and if there is another idiom to process, as determined at step 1020, then at step 1030 a next idiom is added to the database tables. At steps 1040 and 1050 the key words related to the idiom are tagged so as to reference the idiom. If no further idioms remain for processing then the processing ends at step 1060.

### Client-Server Embodiment

In a preferred embodiment, the present invention is implemented as a web service, which processes input text as a request and provides enhancement suggestions as a response. Such a web service can be described using the Web Services Description Language (WSDL), and posted in the Universal Description Discovery and Integration (UDDI) registry.

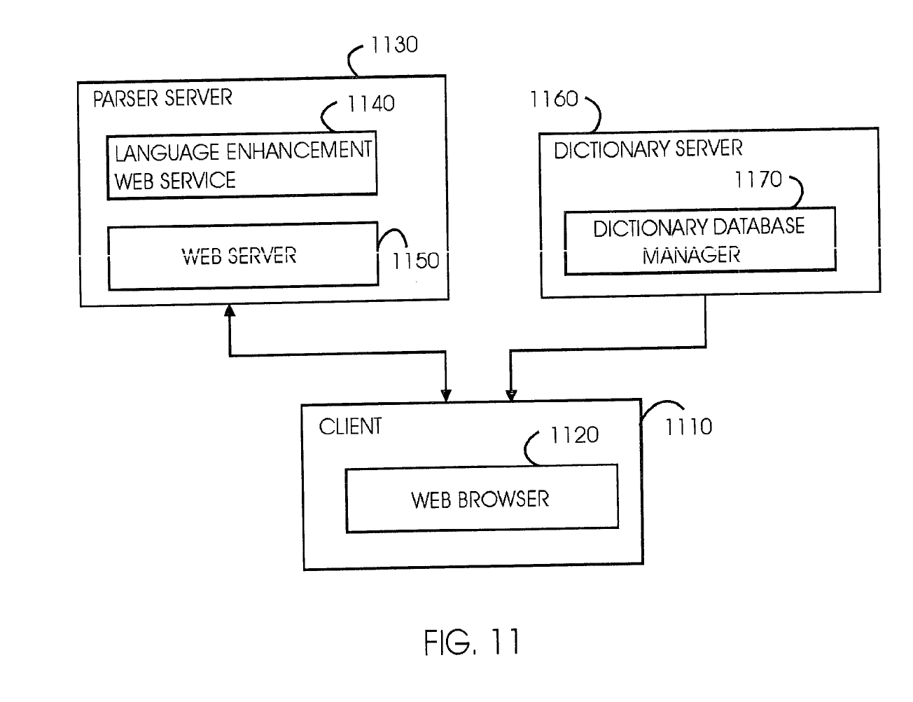

Reference is now made to FIG. 11, which is a simplified block diagram for a web service For a natural language enhancer, in accordance with a preferred embodiment of the present invention. Shown in FIG. 11 is a client computer 1110 that includes a web browser 1120. Client computer sends text to a parser server computer 1130, as input to a language enhancement web service 1140 running on parser server 1130. Parser server 1130 includes a web server 1150 that receives requests, typically using the HTTP protocol, from web browser 1120 and returns responses, typically using the HTTP protocol, to web browser 1120.

Language enhancement web service 1140 analyzes the input text and generates suggestions for enhancement. As described hereinbelow, the suggestions for enhancement include references to words residing on a dictionary server 1160. Dictionary server 1160 includes a database manager 1170, which stores and retrieves words according to indices therefor. Preferably, the references to words within the suggestions for enhancement generated by parser server 1130 are indices into tables within database manager 1170.

When client 1110 receives the response from parser server 1130 with the suggestions for enhancement, it must resolve the word references in order to display the suggestions to a user. Client 1110 sends a request to dictionary server 1160 with one or more word references, and dictionary server 1160 sends the referenced words back to client 1110. Preferably, client 1110 stores the references and the words as key-value pairs within its local cache, in order to have them readily accessible for interpreting future responses from parser server 1130. After resolving the word references within the response from parser server 1130, web browser 1120 can then display the suggestions to a user in a friendly format, preferably within a web page.

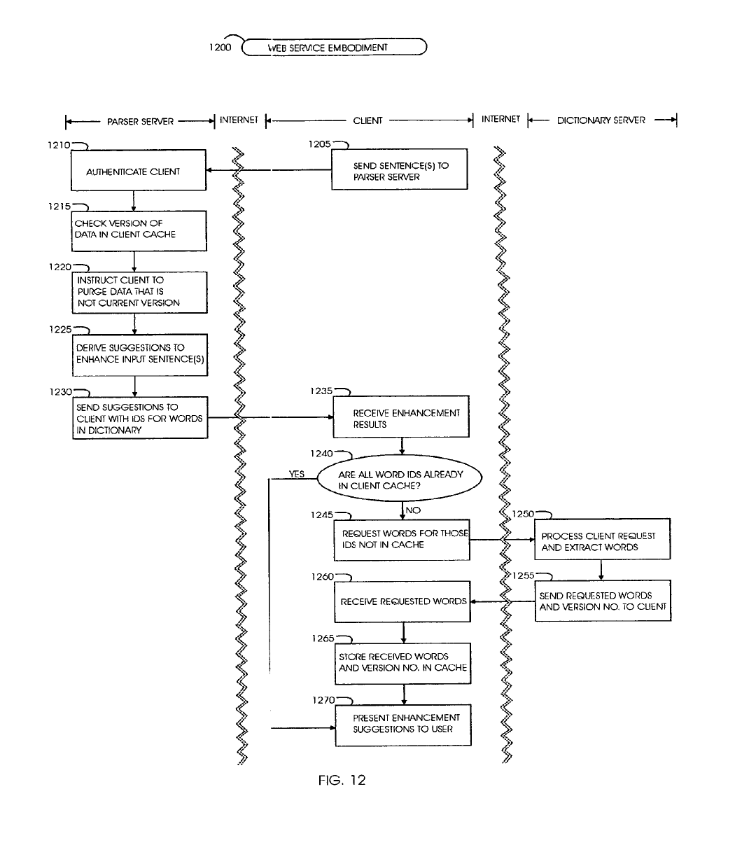

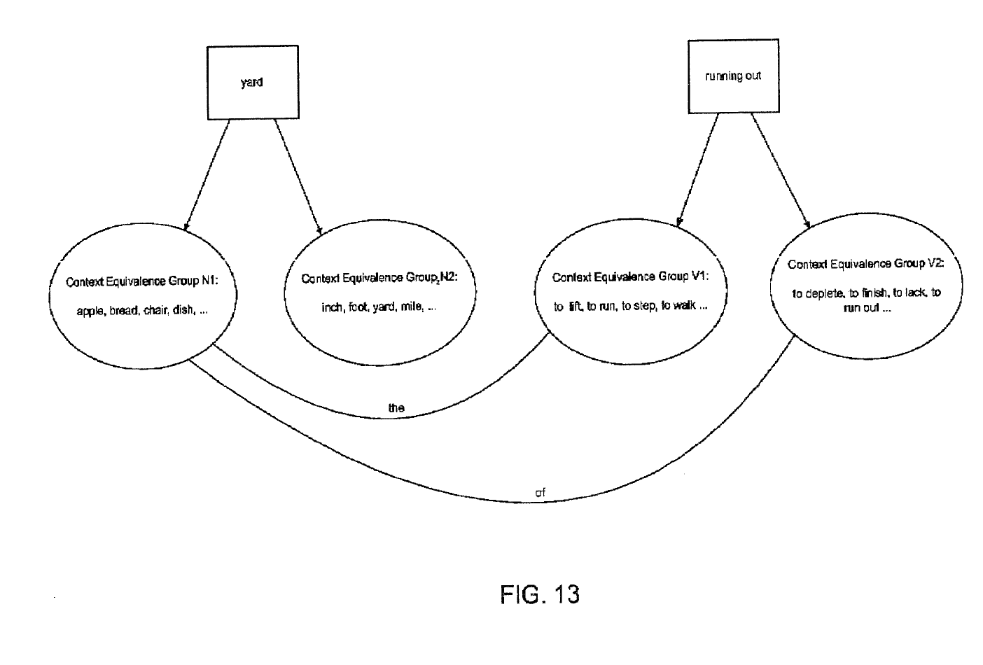

Reference is now made to FIG. 12, which is a simplified flowchart of a web service embodiment of a natural language enhancer, in accordance with a preferred embodiment of the present invention. Shown in FIG. 12 are three columns: a leftmost column for steps performed by a parser server, such as parser server 1130 (FIG. 11); a middle column for steps performed by a client computer, such as client 1110; and a rightmost column for steps performed by a dictionary server computer, such as dictionary server 1160.

At step 1205, the client computer sends one or more sentences to the parser server, as input to a web service. Typically, inputs to web services are formatted as XML documents. At step 1210 the parser server authenticates the client for authorization to use the web service. At step 1215 the parser checks the version of linguistic data residing in the client local cache. The version information may be sent by the client to the parser server together with the input text, or may be provided afterwards by the client upon request by the parser server. If the parser server finds that the version of the data residing in the client cache is not a current version, then at step 1220 it instructs the client to purge old linguistic data from its local cache.

At step 1225 the parser server runs the web service and generates suggestions for enhancement of the input text. At step 1230 the parser server sends the suggestions back to the client, preferably formatted as a web service output. In a preferred embodiment of the present invention, a suggestion for enhancement of a sentence is encoded as four parameters, as follows:

Word_index—the relative position of a word in a sentence
Action_code—a code for a suggested action, including 1—replace, 2—delete, 3—insert before, and 4—insert after
Priority—a code for the importance of following the suggestion, including ′1—must, 2—recommended, and 3—optional
Word_ID—an index for a word in a database table

The following is an example output from the web service corresponding to an input sentence “This are a step for the company”.

Sample Web Service Response

| Word_index | Action_code | Priority | Word_id |
|---|---|---|---|
| 2 | 1 | 1 | 8432 |
| 4 | 1 | 3 | 6532 |
| 4 | 3 | 3 | 7653 |

The first row indicates that the second word in the sentence, namely “are”, must be replaced by the word with index 8432 (“is”). The second row indicates that the fourth word in the sentence, namely “step”, may optionally be replaced with the word with index 6532 (“leap”). The third row indicates that the fourth word in the sentence, namely “leap”, may optionally be preceded by the word with index 7653 (“enormous”). The identities of the words with indices 8432, 6532 and 7653 are determined from the dictionary server, as described hereinbelow.

It may be appreciated by those skilled in the art that other encodings for suggestions may be used instead of the four parameter encoding above.

An advantage of transmitting suggestions in the four parameter form described above is that only suggested changes between original and enhanced text are transmitted, thus minimizing the amount of data that has to be transmitted over the Internet. Referring back to FIG. 12, at step 1235 the client receives the enhancement suggestions, encoded as above, from the parser server. At step 1240 the client checks whether the words indexed in the response, such as words 8432, 6532 and 7653 above, already reside in the client local cache. If not, then at step 1040 the client requests the words from the dictionary server. At step 1045 the dictionary server processes the client request, and at step 1050 the dictionary server sends the requested words back to the client. Preferably, the dictionary server also sends a version number to the client.

At step 1260 the client receives the words, and at step 1265 the client stores the words in its local cache for future reference. Preferably, the client also stores a version number in its local cache, so as to be able to determine whether the cache data is current or outdated. At step 1270 the client displays the suggestions to a user in a friendly format, preferably within a web page. If at step 1240 the client determines that all words indexed in the response are already resident it its local cache, then control proceeds from step 1240 directly to step 1270.

### Database Tables

As described hereinabove, in a preferred embodiment the present invention builds up a database of word relationships. A first table, Table I below, serves as a Thesaurus, and includes a list of synonymous words.

TABLE I
Thesaurus

| | | |
|---|---|---|
| Index | Word | Synonyms |

Words in a sentence serve well-known grammatical roles, and are identified accordingly by type, including inter alia nouns, pronouns, adjectives, verbs, adverbs, prepositions and conjunctions. Preferably, tables are provided for each Grammatical Type, such as Tables II-XII hereinbelow. Table II below is a Noun Table, including fields for single and plural forms of a noun, and an indicator of whether the noun can be used in a countable form.

TABLE II
Table of Nouns

| Index | Single | Plural | Countable? |
|---|---|---|---|
| 1 | cat | cats | yes |

In accordance with a preferred embodiment of the present invention, entries for nouns in the Table of Nouns are also linked to one or more Context Equivalence Groups to which the nouns appear. For example, the entry for the noun “achievement” preferably contains a link to a “performance” Context Equivalence Group, which contains additional nouns such as “performance”, “results” and “work”.

Table III below is a Referential Table, which is a list of first, second and third person noun references.

TABLE III
Referential Table

| Index | Noun Reference |
|---|---|
| 1 | he |
| 2 | it |
| 3 | it's |
| 4 | she |
| 5 | she's |
| 6 | theirs |
| 7 | they |

Table IV below is a Pronoun Table, including fields for single and plural forms of a pronoun.

TABLE IV
Table of Pronouns

| | | | |
|---|---|---|---|
| Index | Pronoun | Single | Plural |

| | |
|---|---|
| 1 | the |

Table V below is an Adjective Table, including fields for comparative and superlative forms of an adjective.

TABLE V
Table of Adjectives

| Index | Adjective | Comparative | Superlative |
|---|---|---|---|
| 1 | bad | worse | worst |

Preferably, entries for adjectives in the Table of Adjectives also include links to one or more Context Equivalence Groupings to which the adjectives belong. For example, adjectives may be linked a “color” Group, a “shape” Group or a “size” Group.

Table VI below is a Quantifier Table, which is an indexed list of quantifiers.

TABLE VI
Table of Quantifiers

| Index | Quantifier |
|---|---|
| 1 | million |
| 2 | thousand |

Table VII below is a Verb Table, including fields for an infinitive form of the verb, a present simple form for third person singular, a present continuous form, a past simple form, and past participle form of the verb.

TABLE VII
Table of Verbs

| | | | | | Past |
|---|---|---|---|---|---|
| Index | Simple | Simple (he, she, it) | Continuous | Past | Participle |
| 1 | break | breaks | breaking | broke | broken |

Preferably, entries for verbs in the Table of Verbs also include links to one or more Context Equivalence Groups to which the verbs belong. For example, an entry for the verb “to run” preferably includes a link to a “physical exercise”

Group of verbs, which includes additional verbs such as “to jump”, “to walk” and “to swim”. Since the verb “to run” also has a meaning of “to manage”, the entry for “to run” preferably also includes a link to a “management” group of verbs. Preferably, verbs followed by different prepositions are treated as different verbs and appear as separate entries in the Table of Verbs.

Preferably, the Table of Verbs contains regular verbs. Auxiliary verbs such as “be”, “can”, “dare”, “do”, “have”, “may”, “must”, “need”, “ought to”,“shall”,“used to” and “will”, are hard coded in an Auxiliary Verb Table.

Table VIII is an Auxiliary Verb Table, which is an indexed list of auxiliary verbs.

TABLE VIII
Table of Auxiliary Verbs

| Index | Preposition |
|---|---|
| 1 | be |
| 2 | can |
| 3 | dare |
| 4 | do |
| 5 | have |

Table IX below is an Adverb Table, including fields for comparative and superlative forms of an adverb.

TABLE IX
Table of Adverbs

| Index | Adverb | Comparative | Superlative |
|---|---|---|---|
| 1 | late | later | latest |

Preferably, entries for adverbs in the Table of Adverbs also include links to one or more Context Equivalence Groups to which the adverbs belong. For example, the adverb “slowly” can be linked to a Context Equivalence Group named “degrees of movement”, which includes other adverbs such as “quickly”.

Table X below is a Preposition Table, which is in indexed list of prepositions.

TABLE X
Table of Prepositions

| Index | Preposition |
|---|---|
| 1 | aboard |
| 2 | about |
| 3 | above |
| 4 | according |
| 5 | according to |
| 6 | across |
| 7 | after |

Preferably, entries for prepositions in the Table of Prepositions also include links to one or more Context Equivalence Groups to which the prepositions belong. For example, a Context Equivalence Group for a preposition can include prepositions that can come before or after a certain type of noun.

Table XI below is a Conjunction Table, which is an indexed list of conjunctions.

TABLE XI
Table of Conjunctions

| | |
|---|---|
| Index | Conjunctions |

Table XII below is an Idiom Table, or Phrase Table with fields for idioms and cues therefor.

TABLE XII
Phrase Table

| Index | Idiom | Cue | Cue Type | Group |
|---|---|---|---|---|
| 1 | Beat the clock | Make it | noun | N1 |

It may be appreciated by those skilled in the art that Tables II-XII are exemplary of a plurality of tables for storing grammatical information. Alternate tables may be used instead of the tables described above.

In a preferred embodiment of the present invention, a Root Table is provided to tabulate variations of a word in different Grammatical Types. Such a table assists in resolving ambiguity.

TABLE XIII
Root Table

| Index | Noun Form | Verb Form | Adjective Form | Adverb Form |
|---|---|---|---|---|
| 1 | attraction | attract | attractive | attractively |

For example, the present invention preferably uses Root Table XIII to correct a sentence like “Beautiful scenes attractive the attention of people”, by suggesting to the user that he replace the adjective “attractive” with the verb “attract”.

In a preferred embodiment of the present invention, Tables II-XIII are generated for each Profile, from training text files corresponding to specific Profiles, as described hereinabove with respect to FIG. 4. Typically, these tables vary from one Profile to another. Thus, the present invention preferably “learns” the contents of Tables II-XII empirically.

In a preferred embodiment of the present invention, Context Equivalence Groups are stored in the database, separate from the above tables. Preferably, each word included within a Context Equivalence Group is indicated by a pointer to the entry corresponding to the word in an appropriate table.

Preferably, the present invention also uses a computer-generated table that serves as a Word Usage Dictionary, and includes information about the ways words are used, as follows:

TABLE XIV
Word Usage Dictionary

| | | | | | | | | |
|---|---|---|---|---|---|---|---|---|
| | | | | Root | Specific | | | |
| Table | Word | | Language | Table | Table | Phrase | Idiom | Sub-idiom |
| Index | Index | Group | Type | Index | Reference | Reference | Reference | Reference |

The fields in Table XIV are:

Word Index—index into the Thesaurus Table (Table I) for a specific word Group—Context Equivalence Group for the word.
Language Type—classification of word as a Grammatical Type, including inter alia noun, pronoun, adjective, verb, adverb, preposition, conjunction, preposition Root Table Index—index into the Root Table (Table XIII)
Specific Table Reference—index into the Noun Table (Table II), or the Pronoun Table (Table IV), or the Adjective Table (Table V), etc., as appropriate to the Language Type
Phrase Reference—a list of one or more indices into the Phrase Table (Table XII), corresponding to phrases that contain the word
Idiom Reference—a list of one or more indices into the Idiom Table (Table XII), corresponding to idioms that can replace the word
Sub-idiom Reference—a list of one or more indices into the Idiom Table (Table XII), corresponding to idioms that contain the word

In a preferred embodiment of the present invention, when a word, such as the word “tea” from text box 120 (FIG. 1) is being analyzed, Word Usage Dictionary Table XIV is first consulted to find indices of the word in Dictionary Thesaurus Table I, in Root Table XIII and in one or more specific tables, as appropriate, among Tables II-XII.

Preferably, words that have more than one meaning are stored in multiple rows of Word Usage Dictionary Table XIV—each such row corresponding to a different meaning.

In a preferred embodiment of the present invention, a Group Matching Table XV is used to resolve ambiguities within a sentence, based on Context Equivalence Groups that are matched. Matching of Context Equivalence Groups is described hereinabove with reference to FIGS. 7A and 7B.

Table XV below is shown with two rows, a first row for the phrase “running out” as used in the sense of exiting, in conjunction with a noun; and a second row for the phrase “running out” as used in the senses of depleting, in conjunction with a noun.

TABLE XV
Root Table

| | | | Connection | |
|---|---|---|---|---|
| Index | Noun Groups | Verb Groups | Word | Priority |
| 1 | N1 (physical object) | V1 (activity) | the | 1 |
| 2 | N1 (physical object) | V2 (lack of, | of | 1 |
| | | abstract) | | |

The first row indicates a noun from Context Equivalence Group N1 used in conjunction with a verb from Context Equivalence Group V1. The second row indicates a noun from Context Equivalence Group N1 used in conjunction with a verb from Context Equivalence Group V2. Context Equivalence Group N1 is a group for nouns that are physical objects, including nouns such as “apple”, “bread”, “chair” and “dish”. Context Equivalence Group V1 is a group for verbs that are used to indicate activity, including verbs such as “to lift”, “to run”, “to step” and “to walk”. Context equivalence group V2 is a group for verbs that are used to indicate lack of something, including verbs such as “to deplete”, “to finish” “to lack” and “to run out”. The connection word shown in Table XV is used to distinguish between usage based on the context of V1, and usage based on the context of V2. Thus, in the context of V1 “running out” is typically connected to the noun by the preposition “the”, whereas in the context of V2 “running out” is typically connected to the noun by the preposition “of”.

To process the sentence “John is running out of the yard” the present invention preferably performs the following steps:

1. Identify Parts of Speech within the sentence; and

2. For each word in the sentence:
a. retrieve the list of Context Equivalence Groups that the word can belong to; and
b. identify the most appropriate Context Equivalence Group, based on combination of the word with other Parts of Speech in the sentence and their Context Equivalence Groups.
   Specifically, the verb “running out” is found to belong to Context Equivalence

Groups V1 and V2, and the noun “yard” is found to belong to Context Equivalence Group N1, as well as another Context Equivalence Group N2 for units of measure. In order to enhance the sentence appropriately, the correct contexts of “running out” end “yard” are preferably determined. Specifically, the connecting preposition “the”, which connects the verb “running out” with the noun “yard” is used, according to Table XV, to resolve the contexts; namely, that

[symbol]

and drawings are to be regarded in an illustrative rather than a restrictive sense.

1. A method for language enhancement, comprising:
receiving with a computer data representing text from a user;
identifying with the computer grammatical constructs within the text;
enhancing the text with the computer by determining at least one alternate text portion based on a user specific profile for at least one original portion of the text, the alternate text portion being consistent with the grammatical constructs of the original portion and having substantially the same meaning as the original portion but conveying a different impression;
wherein the alternate text portion is compliant with a selected predefined profile having a writing style derived from one or more training texts associated with the writing style; and
wherein the user specific profile is based on writing provided by the user.

2. The method of claim 1 wherein the alternate text portion, when substituted for the original portion generates grammatically correct text.

3. The method of claim 1 wherein the alternate text portion includes at least one adjective for a noun from the original portion.

4. The method of claim 1 wherein the alternate text portion includes at least one synonym for an idiom from the original portion.

5. The method of claim 1 wherein the alternate text portion includes at least one idiom for the original portion.

6. The method of claim 1 wherein the alternate text portion includes at least one adverb for a verb from the original portion.

7. The method of claim 1 wherein the original portion of text is a single word.

8. The method of claim 1 wherein the original portion of text is a clause.

9. The method of claim 1 wherein the original portion of text is an idiom.

10. (canceled)

11. The method of claim 1 wherein the selected predefined profile is a legal profile.

12. The method of claim 1 wherein the selected predefined profile is a scientific profile.

13. The method of claim 1 wherein the selected predefined profile is a medical profile.

14. A language enhancement apparatus, comprising:
a memory for storing text from a user;
a natural language parser for identifying grammatical constructs within the text:,
a natural language enricher for enhancing the text by determining at least one alternate text portion based on a user specific profile for at least one original portion of the text, the alternate text portion being consistent with the grammatical constructs of the original portion and having substantially the same meaning as the original portion but conveying a different impression;
wherein the alternate text portion is compliant with a selected predefined profile having a writing style derived from one or more training texts associated with the writing style and
wherein the user specific profile is based on writing provided by the user.

15. The apparatus of claim 14 wherein the alternate text portion, when substituted for the original portion generates grammatically correct text.

16. The apparatus of claim 14 wherein the alternate text portion includes at least one adjective for a noun from the original portion.

17. The apparatus of claim 14 wherein the alternate text portion includes at least one synonym for an idiom from the original portion.

18. The apparatus of claim 14 wherein the alternate text portion includes at least one idiom for the original portion.

19. The apparatus of claim 14 wherein the alternate text portion includes at least one adverb for a verb from the original portion.

20. The apparatus of claim 14 wherein the original portion of text is a single word.

21. The apparatus of claim 14 wherein the original portion of text is a clause.

22. The apparatus of claim 14 wherein the original portion of text is an idiom.

23. (canceled)

24. The apparatus of claim 14 wherein the selected predefined profile is a legal profile.

25. The apparatus of claim 14 wherein the selected predefined profile is a scientific profile.

26. The apparatus of claim 14 wherein the selected predefined profile is a medical profile.

27. A computer-readable storage medium storing program code for causing a computer to perform the steps of:
receiving text from a user;
identifying grammatical constructs within the text;
enhancing the received text by determining at least one alternate text portion based on a user specific profile for at least one original portion of the text, the alternate text portion being consistent with the grammatical constructs of the original portion, and having substantially the same meaning as the original portion but conveying a different impression;
wherein the alternate text portion is compliant with a selected predefined profile having a writing style derived from one or more training texts associated with the writing style: and
wherein the user specific profile is based on writing provided by the user.

28. A web service comprising:
receiving over a data network data representing a request including one or more sentences of natural language text;
algorithmically deriving at least one suggestion for enhancing the one or more sentences based on a user specific profile, the at least one suggestion conveying a different impression but retaining substantially the same meaning, and the user specific profile being based on writing provided by the user; and
returning a response including the at least one suggestion, wherein returning a response includes transmitting data over a data network, which data may be rendered by a client application to show text indicative of the response;
wherein the at least one suggestion is compliant with a selected predefined profile having a writing style derived from one or more training texts associated with the writing style.

29. The web service of claim 28 wherein the at least one suggestion is encoded using a first parameter to designate a word position within a sentence, a second parameter to designate an action, a third parameter to designate a priority, and a fourth parameter to designate at least one word.

30. The web service of claim 29 wherein possible actions include replace, delete, insert, before and insert after.

31. The web service of claim 29 wherein possible priorities include must, recommended and optional.

32. The web service of claim 29 wherein the fourth parameter is a reference to at least one word residing within a dictionary of words.

33. The web service of claim 32 wherein the dictionary of words resides in a dictionary server computer.

34. The web service of claim 28 wherein the at least one suggestion is ranked according to a usage frequency.

35. The web service of claim 28 wherein possible suggestions include replacement of a key word within a sentence with an idiom.

36. The web service of claim 35 wherein the idiom has a similar meaning as the key word.

37. The web service of claim 35 wherein possible suggestions include modification of text associated with the key word.

38. The web service of claim 37 wherein modification of text associated with the key word includes deletion of an adverb preceding the key word.

39. The web service of claim 37 wherein modification of text associated with the key word includes deletion of an adjective preceding the key word.

40. The web service of claim 37 wherein modification of text associated with the key word includes deletion of a preposition preceding the key word.

41. The web service of claim 37 wherein modification of text associated with the key word includes deletion of a verb preceding the key word.

42. The web service of claim 35 wherein possible suggestions include insertion of a connecting verb before the idiom.
